(19) United States
(12) Patent Application Publication
(10) Pub. No.: US 2019/0243891 A1
(43) Pub. Date: Aug. 8, 2019

(54) Method for indicating the temporal and spatial deferment of the generation, manipulation, and arrangement of cells in an electronic spreadsheet

(71) Applicant: Bediako George, Washington, DC (US)

(72) Inventor: Bediako George, Washington, DC (US)

(21) Appl. No.: 15/826,282

(22) Filed: Nov. 29, 2017

Related U.S. Application Data
(60) Provisional application No. 62/427,785, filed on Nov. 29, 2016.

(51) Int. Cl. G06F 17/24; G06F 17/22

(52) U.S. Cl. CPC G06F 17/246; G06F 17/2205; G06F 17/2276

(57) ABSTRACT

Spreadsheets are collections of cells. Special directives may be attached to cells in order to instruct a computing process on how to generate, manipulate, and arrange spreadsheet cells. These directives can be associated with, attached to, or embedded within spreadsheets or spreadsheets cells. Directives are applied according to a directive convention. Application of these directive will allow new spreadsheets to be created at another time and on another computing platform.

### REFERENCES

U.S. Pat. No. 9,824,081 November 2017 Lehmann, et al.

U.S. Pat. No. 9,805,080 October 2017 Joshi, et al.

U.S. Pat. No. 9,805,017 October 2017 Krueger

### BACKGROUND

A spreadsheet is a document, physical or electronic, that represents a collection of cells. Cells contain data items such as numbers, strings, and or dates; they may also contain additional computational instructions, such as formulas, functions, snippets of code, as well as pointers and references to other cells. Cells in a spreadsheet may be arranged in a geometric fashion; typically rows and columns. Rows and columns have unique names. These rows and columns can also be grouped; typically these groups are called worksheets. A cell's location in the spreadsheet is usually specified using a combination of the worksheet name, row and column in which the cell resides. Cell's may also contain other types of information such as data formatting and presentation; form widgets; and descriptive notes or comments.

Cell generation describes the creation of a new cell that is added to the worksheet. Cell generation also refers to other methods of creating cells such as copying existing cells or moving a cell from one location to another. Cells may be generated singly or in groups.

Cell manipulation describes the replacement of an existing cell with a new cell, or updating the contents of an existing cell with new data or computational instructions. Cell manipulation also includes removing a cell from the spreadsheet. Cells may be manipulated singly or in groups.

Cell arrangement refers to the spatial association of cells in columns or rows. This includes specifying or changing the ordering, grouping, or dependencies of cells. Cells may be arranged singly or in groups.

Most spreadsheet applications provide cell generation, manipulation, and arrangement functionality via a user interface. Using Excel for instance, users may create new cells by using a mouse to click on a visual representation of a cell, usually a box, then using their keyboard enter new information into the cell. The user may also choose to later copy, update or remove the cell via Excel's user interface. The user may also choose to sort or group existing cells using Excel's user interface. The user can specify how many cells are generated, manipulated, or arrangement, and makes decisions on starting or stopping generation, manipulation, or arrangement based on the visual feedback provided by the user interface. Other spreadsheet applications mimic Excel quite successfully. This functionality is well understood and has existed for a long time. A salient characteristic of this existing user interface is that the cell generation, manipulation, and arrangement instructions directed by the user via the application's user interface happens immediately and in the spreadsheet itself.

One of the drawbacks to using desktop or web based spreadsheets as a computational tool is that they require hands-on human based interaction to manipulate and generate data cells. This makes it extremely difficult to run spreadsheet computations at scale. In order to overcome this limitation, spreadsheet users often employ computer programmers to translate the calculations in a spreadsheet into another computing language and platform in order to achieve automation and scalability. Spreadsheet translation is time consuming; it is a manual process that, depending on the size of a spreadsheet, could take weeks, months, or even years to accomplish.

### SUMMARY OF INVENTION

This invention describes a method for associating, attaching, or embedding directives within a spreadsheet for the generation, manipulation, and arrangement of cells in the spreadsheet, thereby relieving spreadsheets users of the need to manually perform cell generation, manipulation, or arrangements.

A directive indicates a specific action to be taken before, after, or during the generation, manipulation, or arrangement of cells in a spreadsheet. A user creates a spreadsheet, then associates one or more directives to the said spreadsheet. Each directive indicates an action a server module will perform on the spreadsheet on behalf of the user. The order of which the directives are performed is specified by convention, which is published and known to the user before submission.

Using a submission module, the spreadsheet and input data, along with the associated spreadsheet directives are submitted to an parser module. The parser module extracts the directives, and formulas from the spreadsheet. The directives and formulas along with the input are then passed to the execution module to be evaluated. The execution module processes the input data using the formulas extracted from the spreadsheet in the manner indicated by the associated directives per convention. The results are stored and made available to the user via a viewing module.

### BRIEF SUMMARY OF DRAWINGS

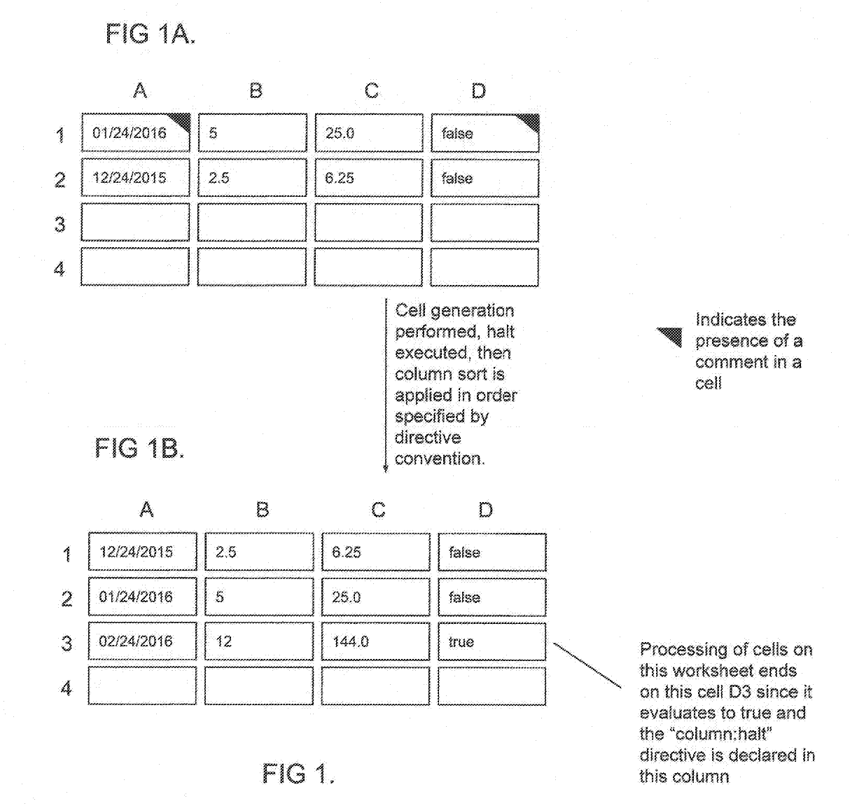

In FIGS. 1A-1B, illustrates how directives are applied to manipulate cells in a worksheet.

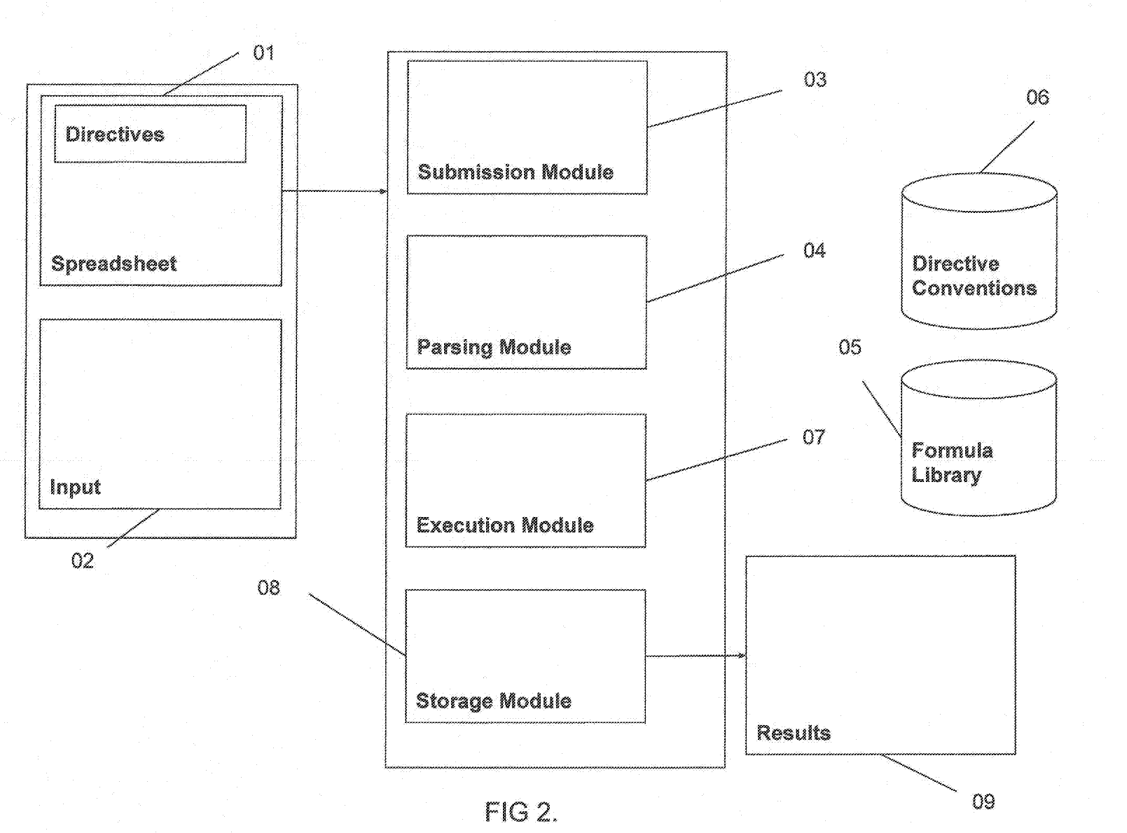

In FIG. 2, the block diagram illustrates the component parts of a system that would use directives to generate spreadsheet and process input.

### DETAILED DESCRIPTION

The present invention provides a method and a system for attaching and processing directives that indicate how a spreadsheet should be created or generated in the absence of a user. This alleviates the need for expensive translation in order to achieve spreadsheet computation at scale. It allows the end user to direct, via the use of attached computational directives, how a spreadsheet is to be computed at scale without requiring the presence of the user and without the need of a computer programmer to translate the spreadsheet into another language or platform. It allows the user to add computational directives using existing spreadsheet functionality.

In one embodiment, the user attaches one or more directives to one or more worksheets in a spreadsheet. One embodiment of associating, attaching, or embedding these cell generation, manipulation, or arrangement directives would be to use the comment or note creation facility available in most spreadsheets. FIG. 1A. illustrates a worksheet tabular view. The rows are enumerated by number whereas the columns are enumerated by letters. A cell label is created by combining the column enumeration and the row enumeration. One skilled in the art will be familiar with this naming convention. The user creates a template of two rows labelled 1 and 2. A halt generation directives is embedded by the user in cell D1 of the spreadsheet. A sort cell directive is embedded by the user in cell A1 of the spreadsheet.

The advantage of this approach is that many spreadsheet application users are familiar with the art of associating, attaching, or embedding a comment in a cell. The exact mechanism for doing so varies from spreadsheet application to application. As an example, a user may wish to specify in a cell or in a column of cells that cell generation should halt. The directive added to a comment in that cell would indicate that the value produced by this cell specifies whether or not cell generation should continue. As an example of one such directive, to be considered for explanation based purposes, the string “halt->true” embedded in the comment would indicate processing should halt if the value of this cell evaluates to “true”. This is illustrated in FIG. 1A. The syntax of this directive is used as an example only and is not critical to understanding how a directive works; other embodiments of this method may use an alternative syntax to represent this directive.

One familiar with the art will appreciate that other methods for associating directives to cells or worksheets exist. One embodiment of associating these types of cell generation, manipulation, or arrangement directives may be to create a worksheet in the spreadsheet and use said worksheet to contain directives. Another embodiment may incorporate these directives in a separate file associated with the spreadsheet. Another embodiment may store this information in a datastore or database. Yet another embodiment is to provide a specialized widget or menu item that allows the user to associate to a cell its generation, manipulation, or arrangement directives. The use of the common spreadsheet construct called a “named reference” is another example of an embodiment that may also be used to hold cell generation, manipulation, and arrangement directives. Still another embodiment may be construed of a mechanism or apparatus for submitting cell generation, manipulation, or arrangement instructions sometime after the spreadsheet was created via a web browser. Another embodiment may store the directive directly in the cell as a value.

The following lists a subset of cell generation, manipulation, or arrangement directives a user may specify via cell association, attachment, or embedding: create cells; copy cells; stop creating cells; filter cells; sort cells after generation; flip cell order; label cells; remove cells; store cells; or discard cells. Other directives may indicate when cell generation may begin, for instance generate cells every weekday at 4 o'clock in the morning. More directives are possible; the presence of this list does not suggest that the set of directives is limited.

The spreadsheet along with its associated directives FIG. 2-01 is then submitted to a spreadsheet parsing module via a submission module as is illustrated in FIG. 2-03. The submission module's responsibility is to receive the spreadsheet along with it associated directives and input data in FIG. 2-02. This information is forwarded to the spreadsheet parsing module in FIG. 2-04. The spreadsheet parsing model is deployed separately from the spreadsheet in this embodiment. One familiar with the art will appreciate that the parser module could be included within the spreadsheet application itself. Parser deployment possibilities include, deployment within the spreadsheet application; deployment in a computer program located on the user's computer; or deployment on a server connected via a network, Internet, or a computing cloud. The parsing module extracts the user's cell directives. The parsing module then sends the spreadsheet along with the extracted directives and spreadsheet input to the execution module FIG. 2-07. The execution module generates new spreadsheets based on the information in the spreadsheet as well as directives associated or embedded within the spreadsheet. The execution module will begin generating cells, moving from left to right then top to bottom following the conventions specified in FIG. 2-06. Each cell is generated by executing the formulas created in each cell using the formula library as referenced in FIG. 2-05. Note that only two rows of cells were originally provided in the template FIG. 1A; the computing process will continue to generate cells until a cell in column D1 evaluates to true resulting in three rows of cells being generated as illustrated in FIG. 1B. Once generation is completed, the cell sorting directive is then applied to the worksheet. Finally, the spreadsheet results are stored by a storage module in FIG. 2-08 and are made available for examination by the user in FIG. 2-09.

The result FIG. 2-08 is a tabular data set with all rows sorted according to the values provided in column A as indicated in FIG. 1B.

It is noted that the syntax or structure of the directives can take on different embodiments. One of the unique attributes of this claim is that a directive can be associated to cell or group of cells (such as a column, a row, or a worksheet) in a spreadsheet. A computing process could follow the associated directives to produce the desired result.

This invention is unique is that it specifies a method for associating with, attaching to or embedding within cells in the spreadsheet, one or more directives that specify the generation, manipulation, and arrangement of cells to be performed at a later time and place. In particular, it enables the user, whether human or computing process to instruct another computing process how to perform cell generation, manipulation, and arrangement on a computing platform at some other time. That future cell generation, manipulation, or arrangement may occur according to a schedule or in reaction to some predefined event, occurrence or incident and may take place on a same or different computing platform than the spreadsheet along with its associated cell generation, manipulation, or arrangement directives were created.

What is claimed is:

1. A method for temporally and spatially deferring the computation and generation of a spreadsheet.

2. The method in claim 1 wherein computational directives are embedded in said spreadsheet.

3. The method in claim 2 wherein said spreadsheet's comments and notes facility are used to associate directives to a cell or a group of cells.

4. The method in claim 2 wherein said spreadsheet's named references are used to associate directives to a cell or a group of cells.

5. The method in claim 2 wherein said spreadsheet's worksheet is used to associate directives to a cell or group of cells.

6. The method in claim 2 wherein said spreadsheet's cell is used to associate directives to a cell or group of cells.

7. A database of directive conventions that specify the order and context a group of directives can be executed.

8. A client system for submitting a spreadsheet along with its associated directives to a submission module. Submission of the spreadsheet using this system may involve network transmission or storage to a file system.

9. A server system configured to accept submissions from the client system in claim 8 and is comprised of a submission module configured to receive submissions of said spreadsheet and associated directives and input from a client as described in claim 8; a parser module configured to extract directives from said spreadsheet; a execution module configured to generate new spreadsheet cells from as specified by the formulas and directives in accordance to the directive execution convention from claim 7.

10. A storage module wherein the resulting data can be stored.

11. A result viewing system wherein the user's resulting data can be made available for consumption.

12. A system in claim 11 wherein the software used to view the resulting data is a web browser.
